(19) United States
(12) Patent Application Publication
(10) Pub. No.: US 2019/0211958 A1
(43) Pub. Date: Jul. 11, 2019

(54) SEALING METHOD

(71) Applicants: Southern Gas Networks PLC, Surrey (GB); Scotland Gas Networks PLC, Edinburgh Scotland (GB); Scotia Gas Networks Limited, Surrey (GB)

(72) Inventors: Nicholas John Ryan, Gloucestershire (GB); Angus McIntosh, Edinburgh (GB); Jonathan Philip Reid, Bristol (GB)

(21) Appl. No.: 16/337,215

(22) PCT Filed: Jul. 28, 2017
(86) PCT No.: PCT/GB2017/052912

§ 371 Date: Mar. 27, 2019

(30) Foreign Application Priority Data
Sep. 28, 2016 (GB) 1616490.7

(51) Int. Cl. F16L 55/164; C09K 3/12; B05D 7/22

(52) U.S. Cl. CPC F16L 55/164; B05D 7/222; C09K 3/12

(57) ABSTRACT

A method of sealing a leak in a pipe comprises introducing a gas-borne cyanoacrylate compound into the pipe.

### FIELD OF THE INVENTION

The present invention relates to a method of sealing a leak in a pipe, a sealant system to be used in conjunction with the method and a pipe comprising a seal resulting from the method.

### BACKGROUND

Gas is transported through a network of pipelines from natural gas terminals to power stations and gas distribution companies which deliver the gas to industrial and domestic consumers. The network is a series of pipes connected by joints, which are traditionally steel, cast iron or plastic, the foundations of which can be decades old. The network forms a pressure envelope of pipes and other vessels, in which the pressure inside the envelope is determined by the operating pressure. The distribution network operates at two pressure ranges, low and medium. The low pressure network is rated to 75 mbar, but is generally operated at 15-30 mbar. The medium pressure distribution network is rated up to 2 bar. Both networks are defined in terms of differential pressures with respect to atmospheric pressures.

Continual exposure over time can cause the joints to weaken until they cease to be effective, leaving holes in the network. The pressure differentials from these holes result in gas leaks. The gases that seep out through these cracks and broken seals generally account for significant carbon release and hence contribute to the greenhouse effect. It therefore continues to be an objective in the gas industry to address gas leaks as quickly and efficiently as possible.

Gas leaks are usually addressed through an invasive procedure involving excavating, drilling into and injecting sealants into the faulty joints. It can be a lengthy and expensive process to excavate the underground pipes, particularly when the pipes are under roads and buildings in densely populated areas. Many safety measures need to be implemented before the work can begin, and a lot of harmful gases may have been released in the time taken to plan and reach the pipes.

Less invasive techniques have been developed and can involve robotic pipe crawlers to access the inside of the pipe. However, such techniques still require drilling into the joints and their reliance on wicking the sealant into existing joint material means they cannot accurately control the injection of the sealant.

Document WO 2015/149023 relates to a non-invasive and remote way of sealing leaks in pipelines. The document discloses a method of forming sealant particles which have an outer surface with a tack range that diminishes over time. The sealant particles flow through the leaky pipes and adhere to surfaces adjacent to a leak and to other particles to form a seal. However, such a method is difficult to use over long distances. This is because there is only a limited time for which the sealant particles have a tack range sufficient to form the seal. Moreover, it is not guaranteed that the sealant particles form a sufficiently impermeable seal.

In light of the current technology, there continues to be a need to provide a sealant which can be controlled and operated over long distances to address gas leaks with an immediate, impermeable and permanent effect. It is therefore an object of the present invention to overcome at least one of the problems in the prior art.

### SUMMARY

According to a first aspect of the present invention, there is provided a method of sealing a leak in a pipe as defined in claim 1.

“Ultra-viscous droplets” in this specification means droplets that have a viscosity of 10³-10⁷ Pa·s. The ultra-viscous droplets are formed as a solvent evaporates from a solution that contains an organic compound solute. The ultra-viscous droplets combine with one another to form a deposit that hardens into a seal on further drying. The resulting seal is a solid that is inert and non-porous with low permeability to gases and liquids. The seal therefore prevents fluids from seeping through leaks, particularly in pipes such as gas pipes, and remains strong for a significant amount of time. Furthermore, the droplets of the liquid aerosol can form a seal after being carried across large distances through the pipe. This means that the liquid aerosol does not need to be locally applied, but rather can be introduced into the pipe remotely. The present invention consequently removes the need to determine the precise location of a leak, which is particularly advantageous in sections of the network that are not easily accessible.

According to a second aspect of the present invention, there is provided a sealant system for sealing a leak in a pipe as defined in claim 25.

According to a third aspect of the present invention, there is provided a gas pipe comprising a seal covering a gas leak as defined in claim 33.

According to a fourth aspect of the present invention, there is provided a method of sealing a leak in a pipe as defined in claim 42.

Compounds comprising cyanoacrylate provide a strong adhesive. Cyanoacrylate compounds are also subject to rapid polymerisation. The present invention introduces a gas-borne cyanoacrylate compound into a pipe containing a leak. The cyanoacrylate compound forms a deposit in the leak progressively that rapidly hardens into a seal within minutes, thereby forming an effectively permanent seal at the site of the leak. The present invention thus provides a rapid and long-term solution for sealing leaks in pipes.

According to a fifth aspect of the present invention, there is provided a sealant system for sealing a leak in a pipe as defined in claim 64.

According to a sixth aspect of the present invention, there is provided a gas pipe comprising a seal covering a gas leak as defined in claim 76.

Embodiments of the present invention will now be described by way of further example only and with reference to the accompanying drawings, in which:

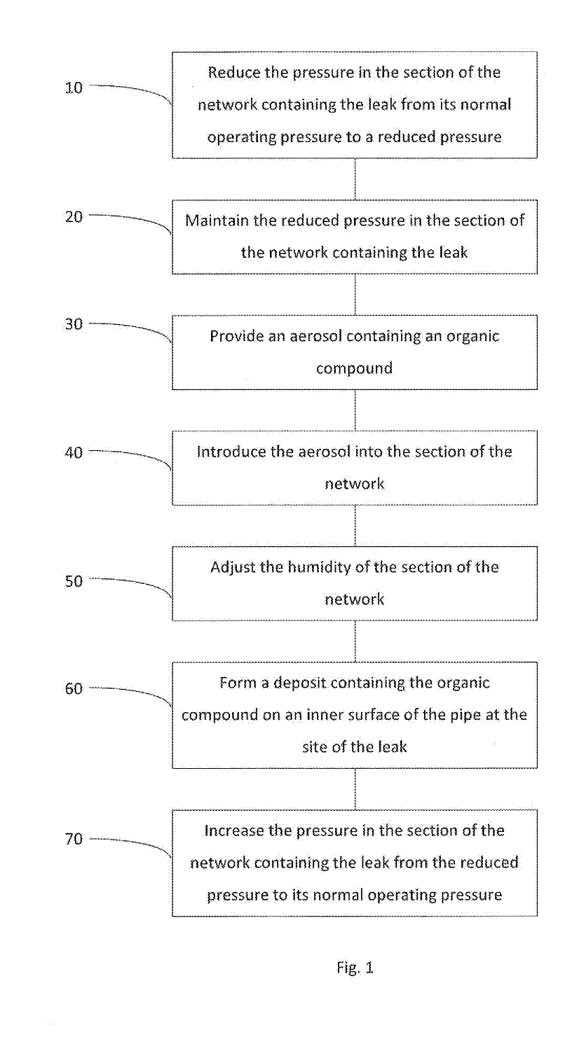

FIG. 1 is a flow diagram of a method for providing a glass seal to seal a gas leak in a pipe according to a first embodiment of the invention;

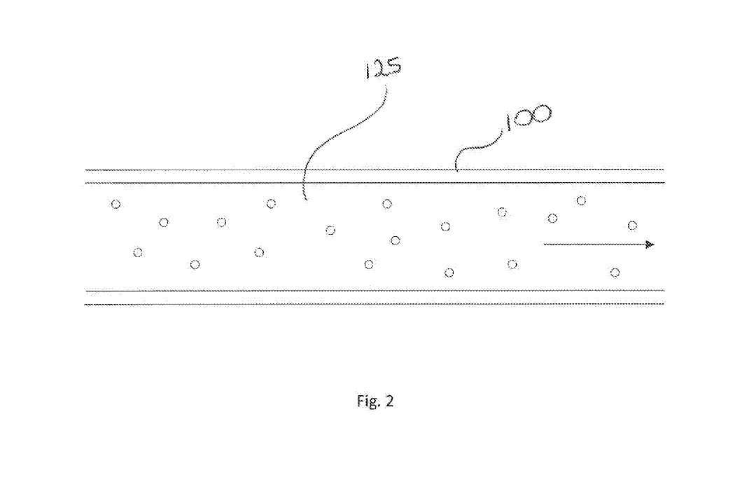

FIG. 2 is a schematic cross-sectional view of a pipe in accordance with step 40 of the flow diagram of FIG. 1;

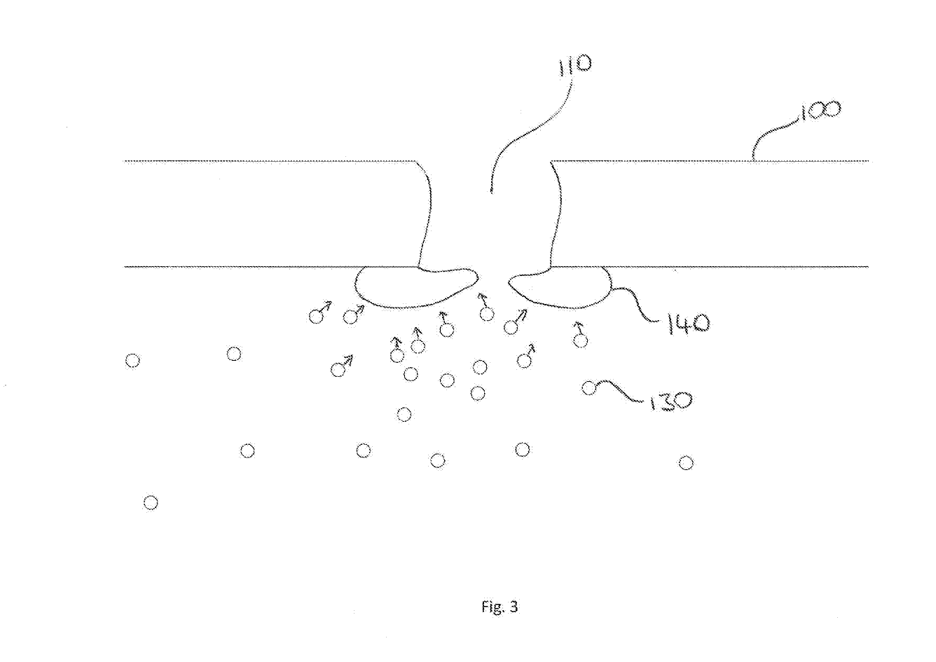

FIG. 3 is a schematic cross-sectional view of a pipe in accordance with step 60 of the flow diagram of FIG. 1;

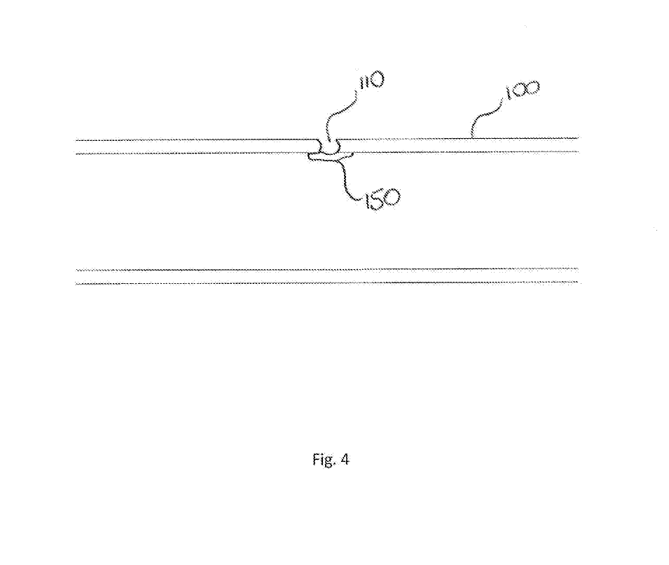

FIG. 4 is a cross-sectional view of a pipe having a sealed leak in accordance with the present invention;

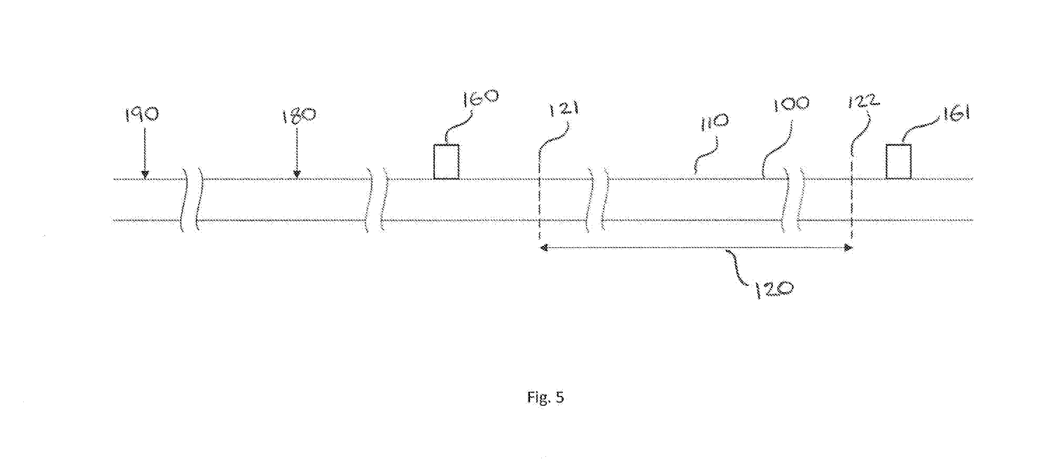

FIG. 5 is a schematic view of a sealant system for providing a glass seal to seal a gas leak in a pipe according to a first embodiment of the invention; and

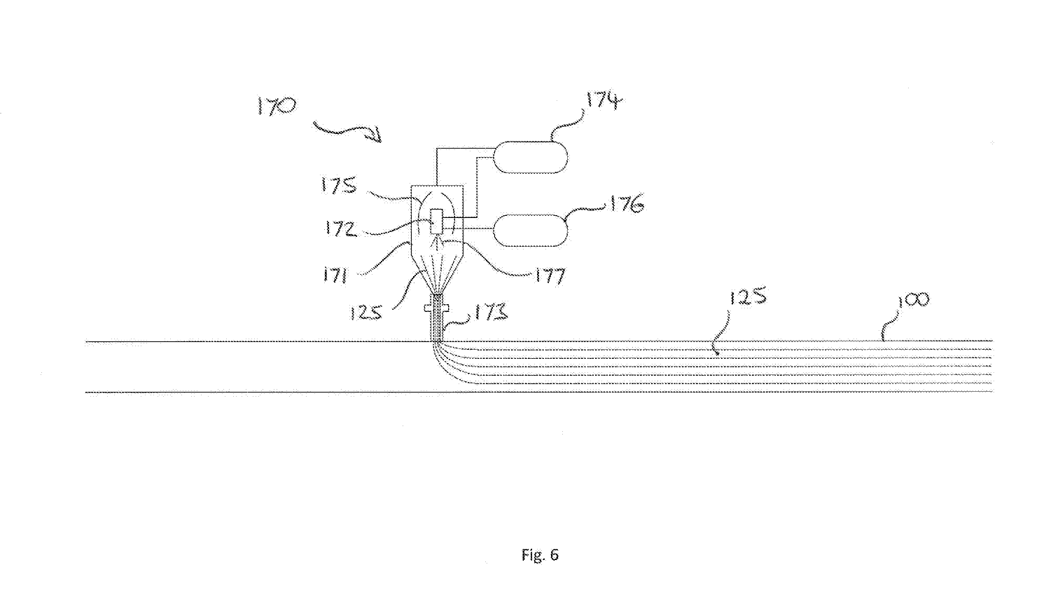

FIG. 6 is a schematic cross-sectional view of an aerosol device installed onto a pipe.

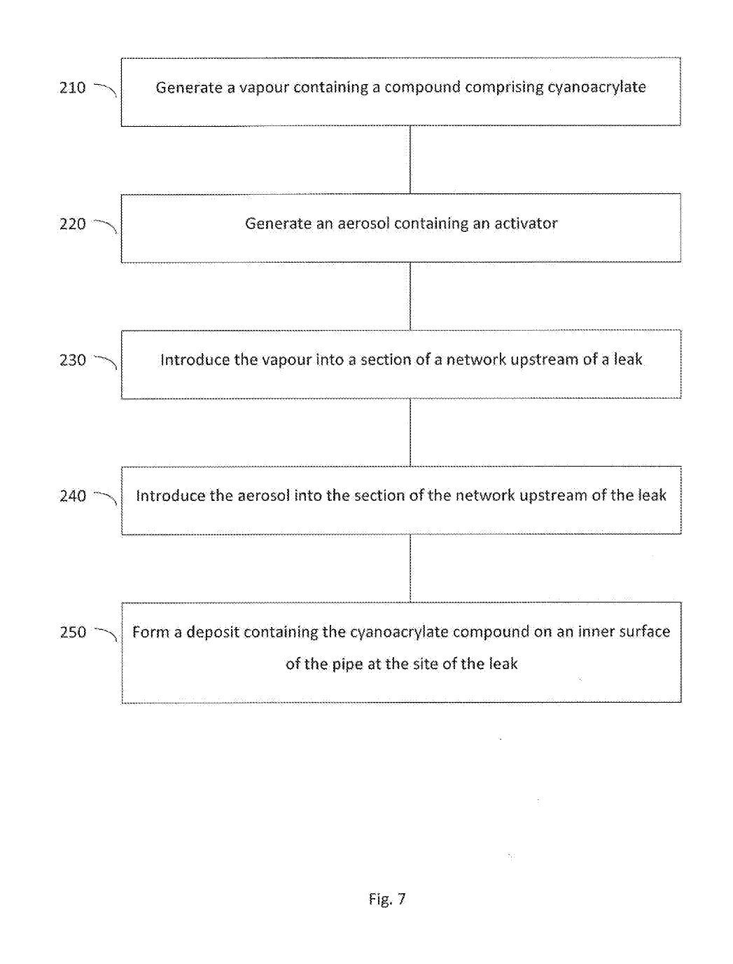

FIG. 7 is a flow diagram of a method for providing a cyanoacrylate seal to seal a gas leak in a pipe according to a second embodiment of the invention;

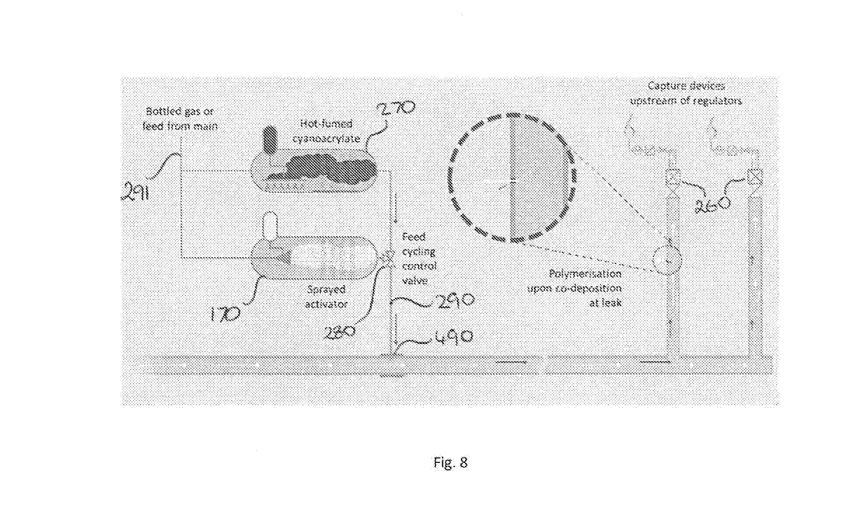

FIG. 8 is a schematic view of a sealant system for sealing a leak in a pipe according to a second embodiment of the invention; and

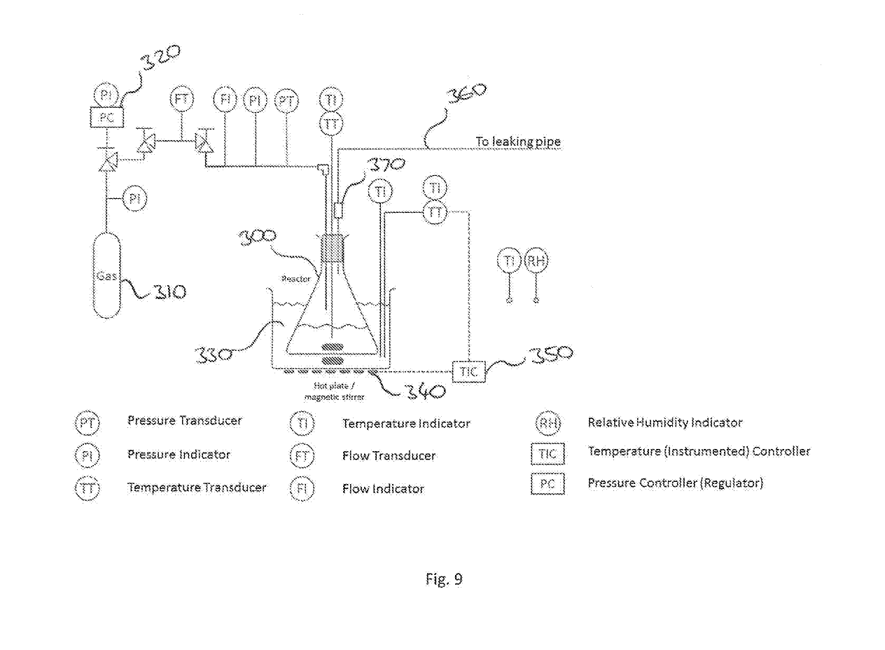

FIG. 9 is a schematic view of a hot-fuming apparatus for generating a vapour according to a second embodiment of the invention;

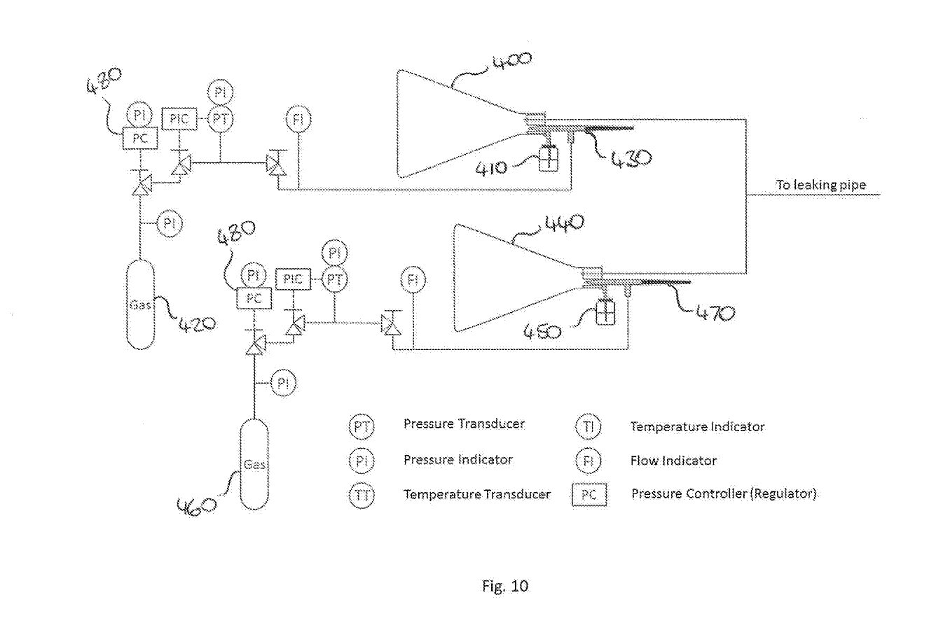

FIG. 10 is a schematic view of a cold-fuming apparatus for generating a vapour according to a second embodiment of the invention.

### DETAILED DESCRIPTION

The present invention relates to a method of sealing a leak in a pipe, a sealant system to be used in conjunction with the method, and a gas pipe comprising a seal covering a gas leak that results from the method.

### First Embodiment

In a first embodiment of the invention, a method of sealing the leak comprises introducing an aerosol of ultra-viscous droplets containing an organic compound into a section of a network containing the pipe having the leak. The droplets flow through the section of the network until they reach the site of the leak. As a result of the pressure differential between the pipe and its exterior, at least some of the droplets of the ultra-viscous liquid aerosol are diverted towards the leak. There is an accelerated flow through the leak that causes a turbulent flow at the site of the leak. The diverted droplets that experience the turbulence at the site of the leak collide with one another and the force of collision can cause them to combine with one other and to the surfaces of the pipe surrounding the leak. The droplets form a deposit, which grows in size as more droplets collide with it until it covers the leak. The deposit then hardens into a seal on further drying.

The present invention will now be described with reference to the figures.

A gas network comprises a pipe 100 having a gas leak 110 as shown in FIGS. 2-5. The pipe 100 is a hollow cylinder, although the pipe 100 may take on the form of a different elongated hollow shape such as a rectangular pipe. The gas pipe 100 has a normal operating differential pressure of up to 75 mbar. The method however may also apply to pipes having normal operating differential pressures of up to 2 bar. A gas flow is transported through the section 120 of the network containing the leak 110 in a laminar flow pattern.

A first preferred embodiment relating to the method for sealing the leak 110 is shown in the flow diagram of FIG. 1. Steps 30, 40 and 60 relate to the process of sealing the leak 110, while steps 10, 20 and 50 relate to setting up the preferable pressure and humidity conditions for carrying out steps 30, 40 and 60. Step 70 relates to returning the pressure and humidity conditions within the section 120 of the network containing the leak 110 back to the normal operating conditions.

Step 10 of the method comprises reducing the pressure in the network section 120 that includes the pipe 100 containing the leak 110. This is an optional step directed to pipes which normally operate with differential pressures greater than 30 mbar. Step 10 of the method comprises reducing this normal operating pressure to a reduced pressure, in which the reduced pressure is a differential pressure less than 30 mbar. In other embodiments, the reduced pressure is a differential pressure less than 15 mbar.

The section 120 of the network containing the leak 110 over which pressure is reduced spans at least a length of 50 m of the network, and preferably a substantial length of around 500-1000 m, with the leak 110 located at an approximate midway point of this length. This is to ensure that both the pressure and humidity conditions within the section 120 of the network are stable and homogeneous. Additionally, as the present invention is carried out on such a substantial section of the network, the need to spend time and resources on determining the precise location of the leak 110 is removed. The precise location of the leak 110 is usually unknown, so this is particularly advantageous for sections of the network which are not easily accessible.

Step 10 is carried out using a preferred connection method of the network operator by bifurcating the path of the laminar gas flow throughout the section 120 of the network containing the leak 110. Since step 10 is carried out on a substantial section 120 of the network, existing infrastructure such as isolation points or network valves can be used as connection points that are in fluid communication with the pipes of the network section 120. The connection points (not shown) are connected via a connecting portion that is a fluid channel separate from and parallel to the pipes of the network section 120. The connecting portion connects a first connection point at a first end 121 of the section 120 to a second connection point at a second end 122 of the section 120, the second connection point providing the laminar gas flow with a single path downstream of the section 120. The laminar gas flow follows a bifurcated path between the first and second connection points so that the pressure in the section 120 is reduced to below 30 mbar and more preferably below 15 mbar. The pressure within the section 120 can be determined using a pressure gauge.

The above connection method prevents impurities from contaminating the gas flow, and further has the advantage of not disrupting the normal operation of the network. Moreover, it removes the need to install costly new infrastructure through means such as hot tapping.

Once the pressure has been reduced in the network section 120, the reduced pressure is maintained in accordance with step 20 of the method for the duration of steps 30-60 until the leak 110 has been sealed.

Step 30 of the method comprises providing an aerosol containing an organic compound. The organic compound is a solute dissolved in a solvent such as water to provide a solution. The solution is then aerosolised to form the liquid aerosol 125.

The solution will firstly be described, and then the aerosolisation of the solution will be described in detail.

A wide range of organic compounds can be used as the solute for the solution, including glass forming compounds. A “glass forming compound” in this specification means a compound that can be dissolved in a solvent and forms a glassy solid as the solvent evaporates from the solution, which hardens into a glass. Glass is a non-crystalline amorphous solid having a liquid-like disordered structure that is inert and non-porous with low permeability to gases and liquids. Glass therefore makes for a highly suitable sealing material to prevent fluids from seeping through leaks 110, particularly in pipes such as gas pipes, and to provide a resistant seal that remains strong for a significant amount of time.

Examples of the organic compound solute include saccharides, cellulose and polyols. A wide range of saccharides can be used, including monosaccharides, disaccharides and polysaccharides. In particular, sugars like trehalose, raffinose and sucrose can be used as the solute.

In order to provide the aerosol according to step 30, the method comprises providing the solution with a predetermined concentration and chemical composition. This is because the concentration and chemical composition of the solution determine the viscosity of the resulting aerosolised droplets 130, which in turn determines the rate at which the droplets 130 form the deposit 140. Droplets 130 can only form a seal 150 when the viscosity of the droplets 130 is ultra-viscous within the range of 10³-10⁷ Pa·s, and droplets 130 form a seal 150 more efficiently within the range of 10⁴-10⁶ Pa·s. This is because there is a bell-curve-like relationship between the viscosity of the droplets 130 and the success rate of forming the seal 150. If the droplets 130 do not fall within the ultra-viscous range, the seal 150 cannot form. This is because droplets 130 which are too viscous with viscosities above 10⁷ Pa·s form a dry powder that passes through the leak 110 without forming a deposit 140 at the site of the gas leak 110. Droplets 130 which are not viscous enough with viscosities below 10³ Pa·s combine at the site of the leak 110, but the resulting deposit 140 is too wet to provide sufficient strength to form a seal 150.

The method therefore comprises controlling the viscosity of the droplets 130 by predetermining the concentration and chemical composition of the droplets 130, so that the stable viscosity of the droplets 130 falls within the ultra-viscous range of 103-10⁷ Pa·s and more preferably within the range of 10⁴-10⁶ Pa·s to provide leak-sealing droplets 130, in which the stable viscosity of the droplets 130 is the steady viscosity value reached between the droplets 130 and their local environment. These leak-sealing droplets 130 can then coagulate to form a deposit 140. For example, the solution may include a sucrose solute dissolved in water at a concentration in the range of 1-6 M, and more preferably within a range of 1.5-3 M.

The concentration of the solution that is aerosolised also determines the size of the resulting droplets 130. This is because more solvent evaporates from more diluted solutions than more concentrated solutions, so that the resulting droplets 130 have a smaller diameter than those from more concentrated solutions. It is preferable that the droplets 130 have a diameter in the range of 1-4 μm.

Droplets 130 having a diameter of 1-4 μm provide a good balance between the longevity of the aerosol in the pipe 100 and the effectiveness of the droplets 130 in sealing a leak 110. Droplets 130 having a diameter of 1-4 μm are small enough to be carried by the gas through a substantial distance of the pipe 100, for example around 500-1000 m, as gravity does not cause them to drop out of the laminar gas flow to a significant extent over these distances. Additionally, droplets 130 of this size are large enough to seal leaks 110 of the size typically found in gas pipes effectively. If the droplets 130 were too small then it would take a larger number of droplets 130 to seal the leak 110 so the sealing method would be less effective. Furthermore, droplets 130 of this size are convenient to generate with a variety of aerosol equipment.

In order to predetermine the concentration correctly to form leak-sealing droplets 130 having a viscosity within the ultra-viscous range of 10³-10⁷ Pa·s and more preferably within the range of 10⁴-10⁶ Pa·s, the method preferably comprises ascertaining the humidity within the network section 120 containing the leak 110. This is because an inverse correlation exists between the humidity of the local environment and the stable viscosity of the droplets 130. As the humidity of the local environment increases, the viscosity of the droplets 130 decreases.

In terms of the concentration of the droplets 130 of the aerosol, diluted solutions result in more humid environments than concentrated solutions, since a higher proportion of solvent has been evaporated during the aerosolisation process. Therefore, diluted solutions provide less viscous droplets 130 than concentrated solutions for a given humidity.

The humidity is also dependent on the chemical composition of the solution. With varying gas phase relative humidity, particles formed from different chemical components show distinct relationships in the amount of water they retain. As water is a plasticiser, they consequently exhibit differing dependencies of viscosity on the relative humidity.

In one example, the relative humidity in the section 120 of the network is adjusted to fall within the range of 45-55% RH by predetermining the concentration and chemical composition of the droplets 130. Droplets 130 containing 2 M sucrose solution can form deposits 140 when the humidity is within the range of 45-55% RH in the network section 120 containing the leak 110.

In one embodiment, before forming the aerosol according to step 30 of the method, a first humidity logger 160 is fitted to a pipe upstream of the leak 110 and a second humidity logger 161 is fitted to a pipe downstream of the leak 110, as shown in FIG. 5. An operator can then take readings from both the first and second humidity loggers 160, 161 in order to ascertain whether the humidity is homogeneous throughout the network section 120 containing the leak 110, and also whether and by how much the humidity needs to be adjusted to form leak-sealing droplets 130.

Once the level of humidity in the network section 120 containing the leak 110 has been determined, the concentration and chemical composition of the solute is predetermined and the aerosol is formed according to step 30 of the method.

The aerosolisation of the solution will now be described.

The solution is aerosolised using an atomiser, such as the TSI Model 9302 atomiser, or an airbrush. An aerosol device 170 for both generating and introducing the liquid aerosol 125 into the pipe 100 is shown in FIG. 6. The aerosol device 170 comprises a housing 171 containing an atomiser 172 and a supply port 173 for introducing the liquid aerosol 125 into the interior of the pipe 100. A first reservoir 174 supplies compressed gas into both the atomiser 172 and the housing 171, in which the gas supplied into the housing 171 is a diluting gas feed 175. A second reservoir 176 supplies the solution into the atomiser 172. A concentrated aerosol 177 is generated by the atomiser 172 and released into the housing 171. The concentrated aerosol 177 is then diluted in the housing 171 by the diluting gas feed 175 to form the liquid aerosol 125 before being supplied into the pipe 100 through the port 173.

The gas from the first reservoir 174 is preferably sourced from the normal gas flow in another section of the gas network. This helps to prevent impurities from contaminating the gas flow throughout the network.

The aerosol device 170 is set up to introduce the liquid aerosol 125 into the network section 120 upstream of the site of the leak 110 in accordance with step 40 of the method. This may involve installing an entry port 180 onto a pipe upstream of the leak 110 for introducing the liquid aerosol 125 into the pipe 100. The solution undergoes a rapid increase in viscosity as the solvent evaporates during the aerosolisation process and, on entry into the pipe 100, the liquid aerosol 125 stabilises within the environment of the network section 120 as the viscosity of the droplets 130 plateaus and reaches a steady value. The liquid aerosol 125 then flows through the network section 120 towards the site of the leak 110, as shown in FIG. 2.

As discussed above, the viscosity of the droplets 130 is determined by the concentration and chemical composition of the droplets 130. However, the viscosity of the droplets 130 can also be controlled once they have been introduced into the network section 120 by adjusting the humidity in accordance with step 50 of the method, if required.

Step 50 of the method comprises adjusting the humidity by introducing a stream of gas that has a controlled humidity. The stream of gas is sourced from the gas flow elsewhere in the network and may be compressed to a desired pressure, as required. For example, the stream of gas may be sourced from a section of the network that excludes the pipe 100 containing the leak 110. The stream of gas is contained in a canister, which is connected via a port 190 to a pipe upstream of the leak 110. The canister supplies the stream of gas directly into the pipe and adjusts the humidity levels as required in at least the network section 120 containing the leak 110, as shown in FIG. 5.

The stream of gas has a predetermined humidity level determined by the level of humidity adjustment required. For example, if the humidity logger readings indicate that the network section 120 containing the leak 110 is too humid to produce leak-sealing droplets 130, the stream of gas is dehumidified as required to provide a dry gas. The canister feeds the dry gas into the pipe, which reduces the humidity in the network section 120. Alternatively, if the humidity logger readings indicate that the section of the network 120 containing the leak 110 is too dry to produce leak-sealing droplets 130, the stream of gas is humidified as required to provide a humid gas and then fed into the pipe to increase the humidity in the network section 120. In practice, the domestic gas supply is generally a dry source of gas, so it is likely that the humidity within the network section 120 will need to be increased to form leak-sealing droplets 130.

Temperature sensors and/or pressure loggers can be positioned on the pipe to relay temperature and/or pressure readings to the operator in some embodiments. In other embodiments, the humidity loggers 160, 161 may be adapted to relay temperature and/or pressure readings as well as humidity readings to the operator.

Controlling the viscosity of the droplets 130 by adjusting the humidity within the network section 120 is particularly advantageous in gas systems where gas leaks have to be differentiated from the holes and branches of pipes in customer supply equipment. The humidity is adjusted to optimise the viscosity of the droplets 130 only in sections 120 of the network that contain the leaks 110. Elsewhere in the network, the humidity can be adjusted to prevent a seal 150 from forming. In this way, the humidity control is a means to ‘switch on’ the invention by providing the conditions for leak-sealing to occur. Therefore, the droplets 130 can be introduced into any part of the network that can transport droplets 130 to the site of the leak 110 without interfering with the normal operation of customer supply equipment.

The relative humidity within the network section 120 can also be adjusted by installing a humidifier and a dehumidifier onto pipes in the network section 120 to give the operator precise control over the humidity of the network section 120. However, predetermining the concentration and chemical composition of the droplets 130 is a more cost effective method of adjusting the viscosity and humidity within the network section 120 than installing a humidifying and dehumidifying system onto the network.

In practice, the leak-sealing droplets 130 having viscosities falling within the optimal viscosity range of 10³-10⁷ Pa·s and more preferably within the ultra-viscous range of 10⁴-10⁶ Pa·s can only form a deposit 140 upon collision with other droplets 130 or with the surfaces of the pipe 100, as shown in FIG. 3. As a result, the leak-sealing droplets 130 do not form a substantial deposit 140 while flowing through the pipes in the network section 120.

The pressure differential at the leak 110 itself however causes droplets 130 to divert from the laminar flow direction towards the leak 110. The resulting turbulent flow at the site of the leak 110 causes at least some of the droplets 130 to combine with each other and bond to the inner surfaces of the pipe 100 surrounding the leak 110 to form a deposit 140. The deposit 140 then grows in size as more droplets 130 collide with it and coagulate, until it substantially covers the fissure of the gas leak 110 in accordance with step 60 of the flow diagram of FIG. 1.

Once the deposit 140 has been formed at the site of the gas leak 110, the deposit 140 dries and solidifies to form a seal 150, as shown in FIG. 4. The seal 150 is effectively impermeable, as a result of its non-crystalline structure. Furthermore, the deposit 140 hardens over time, thereby growing stronger as it dries.

It is preferable to provide a seal 150 that has a permanent effect. One way of providing a permanent seal 150 is with the use of an acrylate compound.

According to an embodiment, the method comprises adding an acrylate, such as a cyanoacrylate compound. The cyanoacrylate compound is initially vapourised using for example an evaporator device. While the deposit 140 is solidifying into a glass seal 150, the resulting acrylate vapour is introduced into a pipe upstream of the site of the leak 110. When the acrylate vapour comes into contact with the deposit 140, its constituent particles bond with the deposit 140 to provide a fast-setting and permanent adhesive. Once the deposit 140 which now contains both the acrylate and the glass forming compound has solidified into a glass seal 150, the resulting seal 150 is effectively impermeable and permanent.

Once the seal 150 has been formed, step 70 of the method is carried out to increase the pressure in the network section 120 containing the leak 110 back to its normal operating pressure. Step 70 is only carried out if steps 10 and 20 were performed.

Step 70 comprises removing the connecting portion that connects the first and second connection points. The laminar gas flow is then fully directed through the network section 120 containing the sealed leak 110, which causes the pressure in the network section 120 to increase from the reduced pressure below 30 mbar back to its normal operating pressure.

The network section 120 then resumes normal operation with the leak 110 efficiently and effectively sealed.

FIG. 5 shows the system for carrying out the method of the first preferred embodiment. In order to set up the system, the connection points used to reduce the pressure in the network section 120 containing the leak 110 are at the first and second ends 121, 122 of the network section 120 and are separated by a length spanning 500-1000 m. The first and second humidity loggers 160, 161 are fitted upstream and downstream of the site of the leak 110, respectively. An entry point 180 for the aerosol device 170 to introduce the liquid aerosol 125 into the network section 120 is installed on a pipe upstream of the leak 110, and may be either upstream or downstream of the first humidity logger 160. An entry point 190 for the stream of gas having a controlled humidity is upstream of the entry point 180 of the liquid aerosol 125 in this embodiment, but may also be positioned downstream of the entry point 180 of the liquid aerosol 125.

### Second Embodiment

In a second embodiment of the present invention, a method of sealing a leak comprises introducing a gas-borne cyanoacrylate compound and forming a seal comprising a cyanoacrylate compound at the site of the leak. Cyanoacrylate compounds provide powerful adhesives, thereby making them ideal for use as sealants.

The cyanoacrylate compound used in the invention may include at least one of an ethyl, butyl and octyl group. Embodiments of the invention may for example include a cyanoacrylate compound comprising at least one of ethyl-cyanoacrylate, ethyl 2-cyanoacrylate, octyl-cyanoacrylate, silica viscosified ethyl-cyanoacrylate, butyl-cyanoacrylate and n-butyl cyanoacrylate.

In one embodiment, the cyanoacrylate compound comprises a combination of ethyl 2-cyanoacrylate and octyl-cyanoacrylate. In another embodiment, the cyanoacrylate compound comprises combined ethyl 2-cyanoacrylate and butyl-cyanoacrylate. In a further embodiment, the cyanoacrylate compound comprises 40-60% ethyl cyanoacrylate and 15-30% n-butyl cyanoacrylate.

Commercial products containing cyanoacrylate compounds suitable for use in the present invention include Permabond® CPP621, Loctite® 4902 and Toolstation® Sika Everbuild CYN50.

Cyanoacrylates polymerise in the presence of hydroxide ions (OH⁻) which may be provided in a great number by an activator to increase the rate of cyanoacrylate polymerisation. A chemical equation representing polymerisation of cyanoacrylate is shown below:

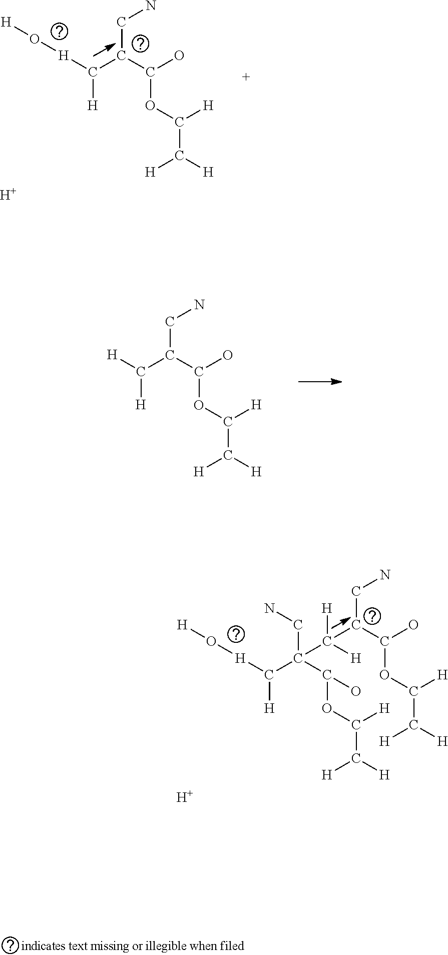

The present invention therefore preferably introduces a compound comprising an activator into the pipe so as to expose the cyanoacrylate compound to the activator in the pipe at the site of the leak. The activator catalyses polymerisation of the cyanoacrylate. Accordingly, the present invention provides a permanent seal that can be formed rapidly and efficiently at the site of a leak.

However, if it is not necessary to form a seal rapidly, the gas-borne cyanoacrylate compound can be introduced into the pipe without an activator. This is particularly the case in applications where the pipe already contains groundwater or alkali contaminants. In such applications, the groundwater or other contaminants present in the pipe act as an activator or catalyst for polymerisation of the cyanoacrylate vapour in the pipe, so that no additional activator is required.

The activator may include a wide range of compositions suitable for catalysing polymerisation of the cyanoacrylate compound. For example, the activator may comprise a hydroxyl group (OH) donor compound. The activator preferably provides a rich source of hydroxide ions for the cyanoacrylate. An example of a compound suitable for use as an activator is N,N-dimethyl-para-toluidine, which has a high pH and is hydroxyl rich. A suitable commercially available activator is Permabond® CSA-NF, which comprises 0.1-1% N,N-dimethyl-para-toluidine and 10-30% of 1,1,1,2,3,4,4,5,5,5-decafluoropentane as a degreasing solvent.

The activator may also be water, which provides a source of OH⁻ ions. In this case it is preferable for the water to be alkaline.

A preferred method of the second embodiment is shown in the flow diagram of FIG. 7.

The preferred method comprises generating a vapour and a liquid aerosol in steps 210 and 220 and then introducing the vapour and the aerosol into a section of a network containing the pipe having the leak in steps 230 and 240.

The vapour comprises a cyanoacrylate compound, in which the molecules of the cyanoacrylate compound are in a dynamic state of perpetual evaporation and condensation below their boiling point.

Reference to a “vapour” in this specification refers to the gas-borne cyanoacrylate compound that is generated as a vapour, and does not exclude a vapour that tends to an aerosol as the cyanoacrylate molecules condense into droplets over time. This is because cyanoacrylate molecules may coalesce to form aerosol droplets.

It is preferable to introduce the cyanoacrylate compound as a vapour into the pipe. The cyanoacrylate molecules in the vapour may subsequently condense such that the vapour tends to an aerosol. By vapourising the cyanoacrylate compound initially, any condensation that occurs within the pipe will only result in cyanoacrylate droplets having minimal diameters less than 1 μm. At such small sizes, the propensity for the cyanoacrylate droplets to settle under gravity is minimised. This is because the propensity for a droplet to settle is dependent on its size as discussed in relation to the first embodiment. Accordingly, the initial generation of a vapour comprising cyanoacrylate means that any subsequent droplets formed in the pipe are small enough to be sufficiently conveyed toward the site of the leak in the laminar flow direction and minimise deposition of cyanoacrylate at undesired locations in the pipe.

The liquid aerosol is a colloidal suspension of liquid droplets including an activator in a gas, such as air.

After carrying out steps 230 and 240 of FIG. 7, the cyanoacrylate vapour and the aerosolised activator droplets traverse through the section of the network in a laminar flow direction along the pipe until they reach the site of the leak. As discussed in the first embodiment, the pressure differential between the pipe and its exterior causes at least some of the cyanoacrylate vapour and the aerosolised droplets to be diverted from the laminar flow direction towards the leak. As a result of the turbulence at the site of the leak, the aerosolised activator droplets collide with the vapourised cyanoacrylate molecules. The activator catalyses polymerisation of the cyanoacrylate compound, and enables rapid formation of long-chain cyanoacrylate compound polymers that form a deposit that bonds to the surfaces of the pipe at the site of the leak in accordance with step 250 of FIG. 7. The forming of the deposit is progressive, as a plurality of cyanoacrylate polymers deposit and combine with one another at the site of the leak. Typically, the deposit forms in the throat of the leak. The deposit then rapidly hardens into a seal within minutes with a permanent effect.

Controlling the Rate of Polymerisation

In practice, as the cyanoacrylate vapour and the aerosolised activator droplets traverse through the pipe toward the leak, the activator droplets may activate cyanoacrylate polymerisation before reaching the leak. This may cause cyanoacrylate polymers to deposit in undesired locations inside the pipe, which may risk in-pipe blockages.

The preferred method of the second embodiment may prevent undesired in-pipe depositing of polymerised cyanoacrylate by introducing further measures for controlling the rate of polymerisation of the cyanoacrylate compound. This means that the seal can be optimally formed at the site of the leak.

One such measure is the provision of an in-built inhibitor in the cyanoacrylate compound for inhibiting polymerisation of the cyanoacrylate compound. In step 230 of the method shown in FIG. 7, the vapour introduced into the pipe preferably comprises a cyanoacrylate compound and an inhibitor. The inhibitor comprises an acidic buffer solution, such as hydroquinone (benzene-1,4-diol), which serves as a pH stabiliser for neutralising the catalyst effect of the activator on the polymerisation of the cyanoacrylate compound. An example of a commercial cyanoacrylate compound comprising an inhibitor is Permabond® CPP621.

Therefore, in the preferred method, if a relatively small number of aerosolised activator droplets collide with vapourised cyanoacrylate molecules upstream of the site of the leak (where they are mixed intensely by turbulence), the inhibitor prevents polymerisation of the cyanoacrylate compound. Accordingly, the present invention can be adapted to protect the network pipe from a build-up of deposited polymerised cyanoacrylate in undesired locations which do not experience intensely turbulent flow.

The preferred method also includes a step of introducing a plasticiser into the section of the pipe containing the leak. The plasticiser comprises a compound adapted to plasticise cyanoacrylate. Preferably, the plasticiser comprises triethyl O-acetylcitrate.

In an embodiment, the method comprises combining the cyanoacrylate compound with the plasticiser prior to the generation of the vapour in step 210, so that the plasticiser is introduced as a vapour into the pipe. In another embodiment, the plasticiser is introduced into the pipe as droplets of the liquid aerosol along with the activator in step 240.

By introducing the plasticiser into the pipe, the present invention reduces the brittleness of the resulting cyanoacrylate seal, thereby improving the permanence of the seal.

An example of a cyanoacrylate compound comprising an in-built inhibitor and a plasticiser has the following concentration: 25-50% ethyl 2-cyanoacrylate, 25-50% triethyl O-acetylcitrate providing a plasticiser, and 0.01-0.1% hydroquinone providing an inhibitor. For example, Loctite® 4902 is suitable for use as a cyanoacrylate compound comprising an inhibitor and a plasticiser.

Capturing Gas-Borne Cyanoacrylate

In practice, some of the cyanoacrylate compound may not be diverted toward the leak, and may therefore continue to be conveyed further downstream of the network pipe in the laminar flow direction. This can be a problem in network pipes having to comply with health and safety regulations, since cyanoacrylates are considered to be toxic in their liquid state and can provide a risk to humans.

The preferred method addresses this problem by comprising a step of installing a capture device 260 downstream of the section of the pipe containing the leak, as shown in the system of FIG. 8. The capture device 260 is configured to capture gas-borne cyanoacrylate. A wide range of capture devices may suffice, including filters comprising cellulose fibre, such as cotton wool. The cellulose fibre readily bonds with cyanoacrylate molecules. Additionally, the efficiency of the cellulose fibre as a capture device can be improved by water wetting. For example, the cellulose fibre may be soaked in water prior to its installation in the pipe. This is because water wetting provides an abundance of hydroxyl groups for activating polymerisation of cyanoacrylate and captures the polymerised cyanoacrylate in the capture device, thereby depleting any gas-borne cyanoacrylate present in the pipe. This capture device presents a cost-effective and efficient means of preventing the cyanoacrylate from passing into undesired locations of the network pipe.

In embodiments including relatively large pipe systems, the method of removing the cyanoacrylate may include introducing a continuous high rate stream of activators into the pipe. This activator stream enables rapid polymerisation of the cyanoacrylate vapour, thereby extinguishing the supply of gas-borne cyanoacrylate in the pipe. The activator stream may be combined with the capture device or used as an alternative method of depleting gas-borne cyanoacrylate from the pipe.

An example of an apparatus for carrying out the preferred method will now be described.

Generation of a Gas-Borne Cyanoacrylate Compound

In the preferred embodiment shown in FIG. 7, the method comprises generating a vapour comprising the cyanoacrylate compound using a vapour generator 270.

The vapour can be generated by any suitable means. In an embodiment, the method comprises fuming the cyanoacrylate compound by a hot-fuming process.

In this specification, a “hot-fuming process” is a process for generating a vapour using a heating element.

An example of an apparatus for the hot-fuming process is shown in FIG. 9. The apparatus comprises a vessel 300 containing a cyanoacrylate compound, which is connected to a reservoir of an inert gas 310 such as nitrogen. Alternatively, as in the first embodiment, gas from another section of the pipe may be used to supply the reservoir. The cyanoacrylate compound comprises an inhibitor and a plasticiser in the preferred method.

A pressure regulator 320 connected to the nitrogen reservoir 310 pumps the nitrogen into the vessel 300 at a pre-determined rate.

The vessel 300 containing the cyanoacrylate compound is located within a heated oil bath 330 for heating the cyanoacrylate compound. The heated oil bath 330 is connected to a heating unit 340, such as a hot plate or a magnetic stirrer. A temperature controller 350 is connected to the heating unit 340 and the heated oil bath 330, and is adapted to regulate the temperature of the heated oil bath 330. The pumping of the nitrogen gas into the vessel 300 in combination with the regulated temperature control creates an environment in the vessel 300 suitable for generating a vapour of the cyanoacrylate compound.

A pipeline 360 connects the vessel 300 to the section of the network pipe comprising the leak. The pipeline 360 comprises a controlled switch 370 that can be opened and closed. While the optimum conditions are being set within the vessel 300 to generate the vapour, the switch 370 is closed, thereby sealing the vessel 300. Once the vapour has been generated within the vessel 300, the switch 370 is adapted to open, so that the vapour is conveyed into the network pipe.

The pipeline 360 may comprise any suitable material, such as copper, steel, iron, polyethylene and polypropylene.

The hot-fuming process described has the advantage that no narrow orifices are required in the apparatus, which could be prone to blockages. However, this process has the disadvantage that distillation of the chemicals in the fluid can occur and that polymerised residue (due to contaminated gas supplied to the device) can build up in the apparatus. This build-up of residue can be managed by using an inhibitor as described above.

In another embodiment, the vapour is generated by a cold-fuming process.

In this specification, a “cold-fuming process” is a process for generating a vapour without using a heating element.

An example of an apparatus for the cold-fuming process is shown in FIG. 10. The apparatus comprises a first vessel 400 connected to a reservoir of a cyanoacrylate compound 410 and a reservoir of gas 420 via a first atomiser 430. The apparatus comprises a second vessel 440 connected to a reservoir of a cyanoacrylate compound 450 and a reservoir of a gas 460 via a second atomiser 470.

As in the first embodiment, the first and second atomisers 430 and 470 may be airbrushes, such as the atomiser 172 shown in FIG. 6. Pressure regulators 480 connected to the gas reservoirs 420 and 460 pump the gas into the first and second atomisers 430 and 470, respectively, at a pre-determined rate. The first atomiser 430 aerosolises the cyanoacrylate compound 410 together with the gas and sprays the resulting aerosol into the first vessel 400. The pressurised gas enables the droplets in the aerosol to effectively evaporate to form a vapour in the first vessel 400. Similarly, the second atomiser 470 aerosolises the cyanoacrylate compound 450 together with the gas from the gas reservoir 460 and sprays the resulting aerosol into the second vessel 440. The pressurised gas enables the droplets in the aerosol to evaporate to form a vapour in the second vessel 440.

The first and second vessels 400 and 440 trap relatively large droplets that low-cost atomisers often produce. This is because large particles tend to settle or collide with the vessel walls to form smaller particles. This means a cheaper atomiser may be used than otherwise possible, while minimising the number of large droplets entering the pipe, thereby preventing large droplets from depositing early in the pipe. In such an arrangement, the liquid collected in the first and second vessels 400 and 440 could be re-circulated back to the reservoir from which the atomiser draws its liquid.

The first and second vessels 400 and 440 are connected to the network pipe via a port 490 installed in the network pipe, as shown in FIG. 8. This may involve installing an entry port into a pipe upstream of the leak for introducing the vapour into the pipe. Any vapour generated in the first and second vessels 400 and 440 can therefore be conveyed to the site of the leak.

The cold-fuming process described has the advantage that a blend of chemicals of differing volatility can be vaporised without heat and thus without a fractional distillation effect distorting the proportions of the chemicals in the vapour relative to that in the liquid. However, it has the disadvantage that it involves passing the liquid through a narrow orifice in the atomiser, which has a propensity to get blocked. The use of an inhibitor as described above minimises this difficulty.

It is possible to combine the hot-fuming apparatus and the cold-fuming apparatus described above in a single leak sealing system containing two sources of cyanoacrylate vapour. This may be useful in applications where two different types of cyanoacrylate vapour are required to seal leaks.

Generation of a Gas-Borne Activator.

In the preferred embodiment shown in FIG. 7, the method comprises generating a liquid aerosol having droplets comprising the activator. In this embodiment, the activator is a solution comprising a donor compound rich in hydroxyl groups that is aerosolised to form the liquid aerosol using for example the aerosol device 170 shown in FIG. 6.

The vapour generator 270 and the aerosol device 170 may be connected to the same port 490 installed into the pipe upstream of the leak. In the configuration shown in FIG. 8, the vapour generator 270 and the aerosol device 170 are connected to the port 490 via a connecting pipeline 290, so as to provide a common feed path into the pipe.

The vapour generator 270 is disposed on an upstream side of the connecting pipeline 290, and the aerosol device 170 is arranged to introduce the liquid aerosol into the connecting pipeline 290 downstream of the vapour generator 270. Furthermore, the reservoirs of gas in both the aerosol device and the vapour generator of the second embodiment may be fed from a section of the normal laminar gas flow of the pipe via a common connecting pipe 291 using the same method discussed in the first embodiment. In this way, the vapour generator 270 and the aerosol device 170 are arranged in parallel with one another.

A feed cycling control valve 280 is installed into the connecting pipeline 290. The valve 280 is disposed at a location where the liquid aerosol is introduced into the connecting pipeline 290. The valve 280 is a three-way valve that is adapted to open and close a flow path of the cyanoacrylate vapour from the vapour generator 270 to the pipe and a flow path of the liquid aerosol comprising the aerosolised activator droplets from the aerosol device 170 to the pipe. Such a configuration is advantageous, since the aerosolised activator droplets may be fed after a predetermined delay following the cyanoacrylate vapour feed into the pipe.

The present invention is not limited to the above however. The cyanoacrylate vapour may be fed after a predetermined delay following the aerosolised activator droplet feed into the pipe. Otherwise, the cyanoacrylate vapour and aerosolised activator droplets may be fed into the pipe at the same time.

The cold-fuming process described above in relation to generating the cyanoacrylate vapour can also be used to generate the activator supplied to the pipe. Cold-fuming an activator compound results in a vapour of the activator, which will tend to become an aerosol in part over time as described above, depending on the activator compound concerned. This activator vapour/aerosol can then be supplied to the pipe as described above. A typical cold-fuming apparatus used to produce the activator vapour/aerosol is a commercially-available airbrush.

Pipe Environment During Sealing

In embodiments for sealing a gas supply pipe, it is preferred that the pipe remain full of its normal content of natural gas (methane) in addition to the compounds introduced during the sealing process. This makes the process simpler and reduces the downtime of the part of the gas supply network being sealed. However, the pipe could alternatively be filled with nitrogen or another inert gas during the sealing process if desired. Air could also be used to fill the pipe during sealing, in which case the air would have to be flushed out of the pipe with an inert gas before re-starting the supply of natural gas to the pipe. The air or inert gas used in these alternatives should be dry in order to avoid unwanted early polymerisation of the cyanoacrylate caused by moisture in the pipe.

The sealing method and system of this embodiment could be applied to other types of pipe carrying other gases, such as ventilation pipes or industrial gas supply pipes. The sealing method and system could also be applied to pipes normally carrying liquids or solids provided that the pipes are emptied sufficiently to allow the cyanoacrylate vapour to enter the leak before performing the sealing process.

### Third Embodiment

Cyanoacrylate in its unpolymerized liquid state has a minor toxicity that may cause skin irritation to humans and animals alike. The present invention may therefore provide a seal with a reduced cyanoacrylate content in pipes where it is necessary under health and safety regulations to limit the amount of liquid cyanoacrylate introduced into pipes or the fluid stream that passes through them.

In order to provide a seal with a reduced cyanoacrylate concentration, one embodiment comprises introducing a liquid aerosol comprising ultra-viscous droplets in accordance with the first embodiment and a cyanoacrylate vapour in accordance with the second embodiment into the section of the pipe containing the leak. In such a configuration, the aerosolised droplets comprise an activator for increasing the rate of polymerisation of the vapourised cyanoacrylate, and are adapted to be ultra-viscous to form leak-sealing glassy deposits at the site of the leak, as discussed in the first embodiment.

Preferably, the aerosolised droplets comprise an aqueous sugar solution. Sugar is an ultra-viscous glass-forming compound adapted to form a glassy deposit, as discussed in the first embodiment. Furthermore, the aqueous solvent of the solution is a hydroxyl group donor compound suitable for use as an activator for catalysing polymerisation of cyanoacrylates. It is preferred for the solvent of the aqueous sugar solution to be alkaline so as to increase the concentration of OH⁻ ions available to the cyanoacrylate and hence increase the activation effect of the solvent.

The aerosolised aqueous sugar solution droplets have a sugar molarity gradient. This is because the aerosolisation of the aqueous sugar solution produces suspended droplets that have a non-uniform composition. Specifically, the droplets have a relatively moist centre and a relatively dry outer skin. This is because as the droplets form, the solvent from the outer portion of the droplet evaporates more rapidly than the solvent in the centre of the droplet. This causes the droplets to have a dry outer skin comprising the sugar solute, which traps most of the water solvent in the centre. While the droplets are sufficiently stable to hold this configuration for a period of time, the stability of the droplets is affected by a change in pressure.

In practice, the droplets are relatively stable while traversing the relatively uniform regulated pressure within the network pipe, and become relatively unstable on reaching the pressure differential at the site of the leak and depositing at the site of the leak. In this way, the aqueous solvent that has been trapped in the droplet is available at the site of the leak for polymerising the cyanoacrylate. At the same time, the sugar solute forms a glassy deposit. Hence, by introducing a liquid aerosol comprising droplets of an aqueous sugar solution, the present invention can control the rate of polymerisation of the cyanoacrylate compound in an efficient and cost-effective manner.

Therefore, the present invention provides a method for rapidly forming a seal and can be adapted to be low cost. This is because the water solvent in the aerosolised aqueous sugar droplets catalyses polymerisation of the cyanoacrylate compound to rapidly form a permanent seal. At the same time, the sugar solute can form a glassy component of the seal. Cyanoacrylate is relatively expensive in comparison with a sugar and water solution. Hence, the method for forming a seal that comprises both cyanoacrylate and sugar-derived glass provides a more cost-effective means of providing a resilient seal.

Additionally, since cyanoacrylate has minor toxicity, the content of cyanoacrylate can be reduced in the seal as desired. This is particularly beneficial as the method can be adapted to comply with health and safety regulations as required.

The foregoing description has been given by way of example only and it will be appreciated by a person skilled in the art that modifications can be made without departing from the scope of the present invention as defined by the claims.

1. A method of sealing a leak in a pipe, the method comprising introducing a liquid aerosol into the pipe,
wherein the liquid aerosol comprises ultra-viscous droplets of a solution, a solute of the solution comprising an organic compound.

2. The method of any one of the preceding claims, wherein the solute comprises a glass forming compound.

3. The method of any one of the preceding claims, wherein the solute comprises one of a saccharide and a polyol.

4. The method of claim 3, wherein the solute is one of a monosaccharide, a disaccharide, a trisaccharide and a polysaccharide.

5. The method of claim 4, wherein the solute is one of raffinose, trehalose, sucrose and cellulose.

6. The method of claim 1 or 2, wherein the solute is a sugar.

7. The method of claim 5 or 6, wherein the solution has a concentration within the range of 1-6 M.

8. The method of claim 7, wherein the solution has a concentration within the range of 1.5-3 M.

9. The method of any one of the preceding claims, wherein a solvent of the solution comprises water.

10. The method of any one of the preceding claims, comprising adjusting the viscosity of the droplets to fall within the range of 10³-10⁷ Pa·s.

11. The method of claim 10, comprising adjusting the viscosity of the droplets to fall within the range of 10⁴-10⁶ Pa·s.

12. The method of any preceding claim, comprising adjusting the humidity of at least a section of the pipe.

13. The method of claim 12 comprising adjusting the humidity to within the range of 45-55% RH in the section of the pipe that contains the leak.

14. The method of claim 12 or 13 comprising introducing a stream of gas having a controlled humidity from a source into the pipe,
wherein the humidity of the stream of gas is different to the humidity of the gas in the section of the pipe.

15. The method of claim 14 comprising one of humidifying and dehumidifying the stream of gas prior to introducing the stream of gas into the pipe.

16. The method of any one of the preceding claims comprising introducing an acrylate compound into the pipe.

17. The method of claim 16, wherein the acrylate compound is introduced in the form of a vapour.

18. The method of claim 17, further comprising vapourising the acrylate compound.

19. The method of any one of the preceding claims comprising forming a deposit containing the organic compound on a surface of the pipe.

20. The method of claim 19, wherein the deposit is formed on a surface of the pipe surrounding the site of the leak.

21. The method of any one of the preceding claims, wherein the pipe is a gas pipe.

22. The method of any one of the preceding claims, further comprising aerosolising the solution.

23. The method of any one of the preceding claims comprising reducing the differential pressure in at least the section of the pipe that contains the leak prior to introducing the liquid aerosol into the pipe.

24. The method of claim 23, wherein the differential pressure is reduced to below 30 mbar.

25. The method of claim 23 or 24 comprising maintaining the reduced pressure in at least the section of the pipe that contains the leak until the leak has been sealed.

26. The method of one of claims 23-25 comprising increasing the differential pressure in at least the section of the pipe that contains the leak after the leak has been sealed.

27. A sealant system for sealing a leak in a pipe, the sealant system comprising the pipe and an aerosol device connected to the pipe,
wherein the aerosol device is adapted to aerosolise a liquid to form an aerosol, and
the aerosol device is further adapted to introduce the aerosol into the pipe.

28. The sealant system of claim 27, wherein the aerosol device comprises an atomiser.

29. The sealant system of claim 28, wherein the atomiser is adapted to generate a concentrated aerosol, and the aerosol device further comprises:
a housing containing the atomiser, the housing for diluting the concentrated aerosol;
a first reservoir adapted to store a gas; and
a second reservoir adapted to store a solution containing an organic compound;
wherein the first reservoir is connected to the housing and the atomiser, and the second reservoir is connected to the atomiser.

30. The sealant system of any one of claims 27-29 further comprising a source of gas and a humidity adjustment device, wherein the humidity adjustment device is adapted to adjust the humidity of the gas from the source, and the source is adapted to introduce the gas having a controlled humidity into the pipe.

31. The sealant system of claim 30, wherein the humidity adjustment device comprises at least one of a humidifier and a dehumidifier.

32. The sealant system of any one of claims 27-31 comprising at least one humidity logger adapted to monitor the humidity of the pipe.

33. The sealant system of any one of claims 27-32 comprising a temperature sensor adapted to monitor the temperature of the pipe.

34. The sealant system of any one of claims 27-33 further comprising at least two connection points in fluid communication with the pipe and a fluid channel separate from the pipe connecting the connection points, the leak located between at least two of the connection points.

35. A gas pipe comprising a seal covering a leak, wherein the seal is provided on an inner surface of the gas pipe, and the seal comprises a glass forming compound.

36. The gas pipe of claim 35, wherein the seal comprises a glass material.

37. A gas pipe comprising a seal covering a leak, wherein the seal is provided on an inner surface of the gas pipe, and the seal comprises one of a saccharide and a polyol.

38. The gas pipe of any one of claims 35-37, wherein the seal further comprises an acrylate.

39. A method of sealing a gas leak in a gas pipe substantially as hereinbefore described with reference to FIGS. 1-6.

40. A sealant system for sealing a gas leak in a gas pipe substantially as hereinbefore described with reference to FIGS. 5 and 6.

41. A gas pipe comprising a seal covering a gas leak substantially as hereinbefore described with reference to FIG. 4.

42. A method of sealing a leak in a pipe, the method comprising introducing a gas-borne cyanoacrylate compound into the pipe.

43. The method of claim 42 further comprising introducing a gas-borne activator into the pipe,
wherein the activator is adapted to catalyse polymerisation of the cyanoacrylate compound.

44. The method of claim 42 or 43, wherein the gas-borne cyanoacrylate compound is a vapour comprising the cyanoacrylate compound.

45. The method of claim 43, wherein the activator is introduced into the pipe as droplets of a liquid aerosol.

46. The method of any one of claims 42-45, wherein the cyanoacrylate compound comprises at least one of an ethyl, butyl and octyl group.

47. The method of claim 46, wherein the cyanoacrylate compound comprises at least one of ethyl-cyanoacrylate, ethyl 2-cyanoacrylate, octyl-cyanoacrylate, silica viscosified ethyl-cyanoacrylate, butyl-cyanoacrylate, and n-butyl-cyanoacrylate.

48. The method of any one of claims 42-47, wherein the cyanoacrylate compound comprises an inhibitor adapted to inhibit polymerisation of the cyanoacrylate.

49. The method of claim 48, wherein the inhibitor is an acidic buffer solution.

50. The method of claim 48 or 49, wherein the inhibitor comprises benzene-1,4-diol.

51. The method of any one of claims 42-50 further comprising introducing a gas-borne plasticiser into the pipe, the plasticiser for plasticising a cyanoacrylate polymer.

52. The method of claim 51, wherein the plasticiser comprises triethyl O-acetylcitrate.

53. The method of claim 43 or 45, wherein the activator is a hydroxyl group donor compound.

54. The method of claim 53, wherein the activator comprises N,N-dimethyl-para-toluidine.

55. The method of claim 53 or 54, wherein the activator is a solvent in an aqueous sugar solution.

56. The method of any one of claims 42-55 comprising generating a vapour comprising the cyanoacrylate compound and then introducing the vapour into the pipe.

57. The method of claim 56, wherein the step of generating the vapour comprises hot-fuming a liquid comprising the cyanoacrylate compound.

58. The method of claim 56, wherein the step of generating the vapour comprises cold-fuming a liquid comprising the cyanoacrylate compound.

59. The method of any one of claims 45-58 comprising generating a liquid aerosol comprising droplets including the activator and then introducing the liquid aerosol into the pipe.

60. The method of any one of claims 42-59 further comprising forming a deposit on a surface of the pipe, the deposit comprising the cyanoacrylate compound.

61. The method of any one of claims 42-60 further comprising installing a capture device downstream of the section of the pipe containing the leak.

62. The method of any one of claims 42-61 further comprising filtering fluids in the pipe so as to capture the gas-borne cyanoacrylate.

63. The method of claim 60 further comprising introducing a stream of gas into the pipe after the step of forming a deposit, the stream of gas comprising an activator.

64. A sealant system for sealing a leak in a pipe, the sealant system comprising the pipe, a vapour generator and an aerosol device,
wherein the vapour generator is adapted to evaporate a liquid to form a vapour,
the aerosol device is adapted to aerosolise a liquid to form an aerosol, and
the vapour generator is adapted to introduce the vapour into the pipe, and the aerosol device is adapted to introduce the aerosol into the pipe.

65. The sealant system of claim 64, wherein a source of liquid comprising a cyanoacrylate compound is provided in the vapour generator so as to form a vapour comprising the cyanoacrylate compound.

66. The sealant system of claim 65, wherein a source of liquid comprising an activator for the cyanoacrylate compound is provided in the aerosol device so as to form an aerosol comprising droplets including the activator.

67. The sealant system of claim 65 or 66 further comprising a capture device for capturing gas-borne cyanoacrylate, wherein the capture device is installed in the pipe downstream of the leak.

68. The sealant system of claim 67, wherein the capture device comprises cellulose fibre.

69. The sealant system of claim 68, wherein the capture device comprises cotton wool.

70. The sealant system of any one of claims 67-69, wherein the capture device contains an activator.

71. The sealant system of any one of claims 64-70, wherein the vapour generator comprises a hot-fuming apparatus.

72. The sealant system of claim 71, wherein the hot-fuming apparatus comprises:
a vessel for holding a cyanoacrylate compound;
a heating element for heating the cyanoacrylate compound; and
a pipeline connecting the vessel to the section of the pipe containing the leak.

73. The sealant system of claim 72, wherein the hot-fuming apparatus further comprises a temperature controller adapted to control the temperature of the heating element.

74. The sealant system of any one of claims 64-70, wherein the vapour generator comprises a cold-fuming apparatus.

75. The sealant system of claim 74, wherein the cold-fuming apparatus comprises an atomiser for generating an aerosol.

76. A gas pipe comprising a seal plugging a leak, wherein the seal is provided at least partly within a hole in a wall of the gas pipe, and the seal comprises a cyanoacrylate compound.

77. The gas pipe of claim 76, wherein the seal further comprises a plasticiser.
